(19) United States
(12) Patent Application Publication
(10) Pub. No.: US 2024/0080945 A1
(43) Pub. Date: Mar. 7, 2024

(54) Cold Weather Hand Warmer Device

(71) Applicants: Neal Marsh, Hemlock, MI (US); Josette Marsh, Hemlock, MI (US)

(72) Inventors: Neal Marsh, Hemlock, MI (US); Josette Marsh, Hemlock, MI (US)

(21) Appl. No.: 17/903,381

(22) Filed: Sep. 6, 2022

(51) Int. Cl. H05B 3/34; H05B 1/02

(52) U.S. Cl. CPC H05B 3/342; H05B 1/0272; H05B 2203/003; H05B 2203/03

(57) ABSTRACT

A cold weather hand warmer device construction for attaching to any hand held objects such as a fishing rod, umbrella, wheelchair, snow shovel, baby stroller and/or when operating a motorcycle or riding a bicycle. The flexible hand warmer is made up of various components including the flexible hand warmer with its 3 to 4 layer made from flexible soft material combined with a built-in heating mechanism. The portable battery pouch containing various components including a rechargeable battery, a touch screen heating controller attached to the control interface board. The battery pouch further includes an adjustable strap to help fix around most objects. The cold weather hand warmer device described herein once attached to a hand held object can be manually-operated by the heating controller which is electrically connected to the control interface which in turn controls the flow of power from the rechargeable battery.

### FIELD OF THE INVENTION

The present invention relates generally to flexible heating device and, more particularly, to heating devices especially adapted for use with hand held implements pertains to keeping a person's hands warm during cold conditions.

### BACKGROUND OF THE INVENTION

Many people in a variety of location enjoy the outdoors. Some individuals work or play in colder climates, either because that is the type of climate in which their target resides, or because the individual is local to that climate. While outdoor, the individual typically holds a hand held object for sporting equipment, and tools such as ski poles, archery bows, fishing poles and snow shovel or when users operate motorcycles or snowmobiles are well known. Therefore, there exists a need for an electrically heating device for the shaft of an apparatus in order to warm the hands of a user.

For ease of installation on a wide variety of hand held object having a wide variety of handle diameters, it would be desirable if a heating device were in the form of a wrap around and locked in place that IS readily attaches to and is readily removed from a hand held object. Moreover, to assure that the heating device does not inadvertently slide off of the handle, it would be desirable if a strong hook and loop fastener were employed to prevent the heating device from sliding off of the handle.

The use of heated device is known in the prior art. More specifically, heated device heretofore devised and utilized for the purpose of heating hand held implements are known to consist basically of familiar, expected and obvious structural configurations, notwithstanding the myriad of designs encompassed by the crowded prior art which have been developed for the fulfillment of countless objectives and requirements.

In the related art, many methods of improving fishing rods for use with cold weather or ‘ice-fishing’ are known. Of these, many methods of heating the handles of fishing rods are also known. These range from wrapping heated and insulated covers external to the handle, to various methods of adding a heat source within the handle.

Other devices have been disclosed in the known art that relate to fishing rods and poles. These include devices that have been patented and disclosed in patent application publications. However, the devices in the known art have several drawbacks. Some devices are comprised of multiple layers and heat the entire length of the fishing pole, thereby unnecessarily heating portions of the pole which the individual does not typically touch, resulting in inefficiency. Some devices attach onto the fishing pole and are not protected from the elements and water inherent in fishing. Some devices operate by burning a fuel element and venting the exhaust to produce warmth. Such devices are wasteful and can be an unsafe fire hazard.

As another type of solution to the hands of fishermen being cold, throughout the years is to wear gloves. However, when a fisherman wears gloves, it may not be easy to apply bait to a hook. Moreover, when wearing gloves, the fisherman may not be as sensitive to small tugs on the fishing line that might be felt if gloves were not worn. Furthermore, while wearing gloves, the fisherman may not be able to operate a reel handle efficiently. Therefore, in view of the abovementioned problems associated with a fisherman's wearing gloves, it would be desirable if there were a device which provided warmth to a fisherman's hands without the need to wear gloves.

Conventionally, electrically heated hand grips have been utilized on handlebars of vehicles. Examples of such vehicles include snow mobiles, bicycles, snow blowers, and motorcycles. When users operate motorcycles or snowmobiles in cold weather, their hands get cold, even with warm clothing. It is important that a person operating such a vehicle concentrate on driving, rather than on physical needs. As a result, heated hand grips have been used for such vehicles. While these devices fulfill their respective, particular objective and requirements, the aforementioned heated hand grips do not describe a rechargeable easy to install hand warmer for keeping a person's hands warm during cold conditions.

The present invention substantially diverges in design elements from the known art and consequently it is clear that there is a need in the art for an improvement to existing heating devices and in doing so provides an device primarily developed for the purpose of keeping a person's hands warm during cold conditions. Therefore, it can be appreciated that there exists a continuing need for a new and improved heating device which can be used for keeping a person's hands warm during cold conditions. In this regard the present invention substantially fulfills these needs.

### BRIEF DESCRIPTION OF THE INVENTION

The primary object of the invention is to provide a cold weather hand warmer device made from a flexible material that can be wrapped around variety types of hand held objects to keep your hands warm in cold weather, eliminating or reducing the need for thick or thin gloves while maintaining dexterity and comfort. The configuration of the cold weather hand warmer device allows many types of outdoor indoor work, like driving, riding, fishing, walking and outdoor work etc.

Another object of this invention is to provide an cold weather hand warmer device that has particular application for use outdoors in cold weather, for example being well adapted to fishing by wrapping around the grip end of a fish pole to keep your hands warm in cold weather, eliminating or reducing the need for thick or thin gloves while maintaining dexterity and comfort.

In order to achieve this aspect, the cold weather hand warmer device once attached to a hand held object can be manually-operated by the heating controller which is electrically connected to the control interface which in turn controls the flow of power from the rechargeable battery. The heating controller has an power on/off switch comprises of four positions, a first position is for turning the device off, a second position is for providing a low amount of heat, a third position for providing a medium amount of heat and a forth position for providing a high amount of heat. Moreover the rechargeable battery can be charged by connecting the battery to USB plug located in the pocket of the battery pouch and could be fully charged around 3-4 hours.

The present invention is made up of various components including the flexible hand warmer with its 3 to 4 layer made from flexible soft material combined with a built-in heating mechanism. The portable battery pouch containing various components including a rechargeable battery, a touch screen heating controller attached to the control interface board. The battery pouch further includes an adjustable strap to help fix around most objects.

The cold weather hand warmer device has a particular application for use in cold weather, being well adapted to fishing rods, motorcycles, bicycles, wheel chairs, snow shovels, strollers, walking sticks, umbrella and other equipment and devices and is characterized by having associated therewith a hand warmer.

These and other features and advantages of the invention will be readily apparent from the following detail description of an embodiment thereof and reference to the accompanying drawing.

### BRIEF DESCRIPTION OF THE DRAWING

FIG. 1 is a perspective view of the cold weather hand warmer device position around a fishing rod handle according to the present invention.

FIG. 2 is a perspective, partial cross section view of the cold weather hand warmer device showing in accordance with the present invention.

FIG. 3 is a perspective view of the cold weather hand warmer device showing the major components of the present invention.

FIG. 4 is an exploded view of the cold weather hand warmer in FIG. 2, showing the relationship between component in accordance with the principles of the present invention.

FIG. 5 is a detail exploded view of the heating coil assembly of FIG. 4, showing the relationship between components of the present invention.

FIG. 6 is an exploded view of the portable battery pouch in FIG. 2, showing electrical components of the cold weather hand warmer device.

FIG. 7 is a schematic view of the flexible hand warmer in FIG. 2 Illustrating the operation of the heating unit in in accordance with the present invention.

FIG. 8 is illustrates view of a bicycle incorporated in the present invention.

FIG. 9 is illustrates view of a cold weather hand warmer device depicted on a shovel, according to a preferred embodiment of the invention.

FIG. 10 is illustrates view of a cold weather hand warmer device depicted on a wheel chair, according to a preferred embodiment of the invention.

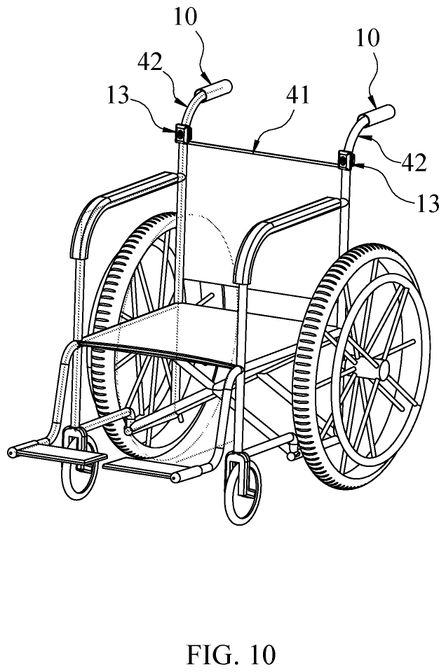

FIG. 11 is illustrates view of a cold weather hand warmer device depicted on an umbrella, according to a preferred embodiment of the invention.

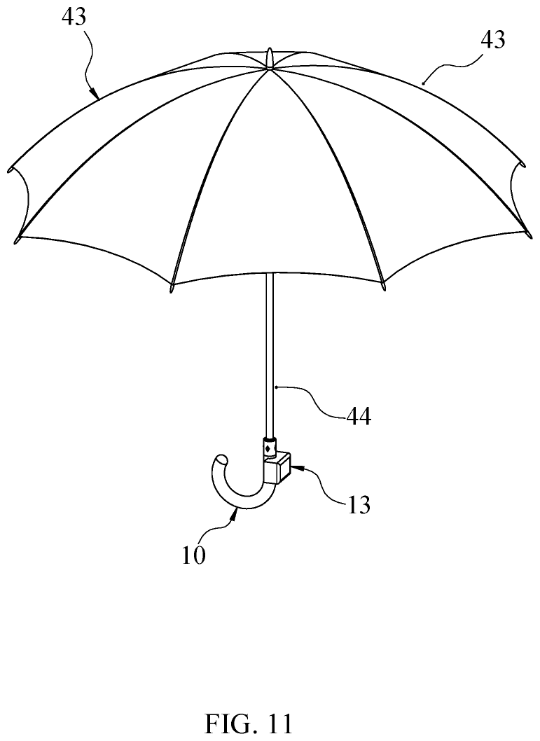

### DESCRIPTION OF CERTAIN EMBODIMENT OF THE PRESENT INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

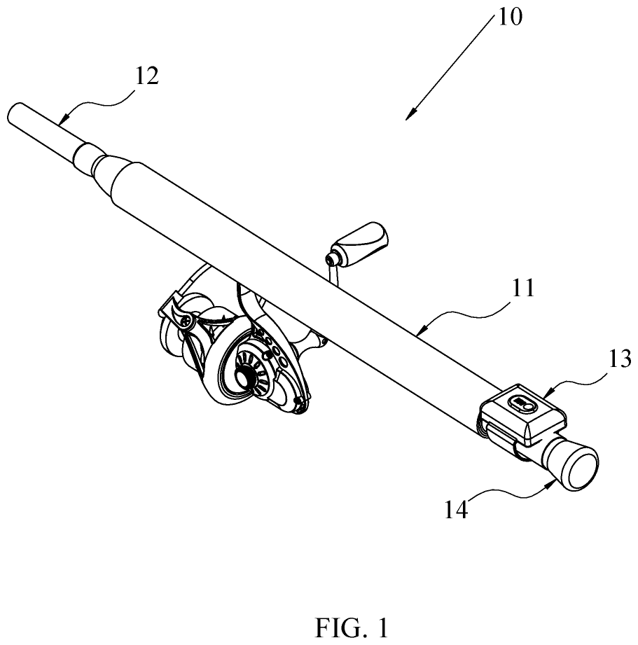

The present invention shown in FIG. 1 illustrates the cold weather hand warmer device 10, that can be wrapped around variety types of handles to keep your hands warm in cold weather, for example in use with a fishing rod 12, comprising of an flexible hand warmer 11 wrapped around the fishing rod handle 14 powered by the portable battery pouch 13 attached to the end of the fishing rod handle 14.

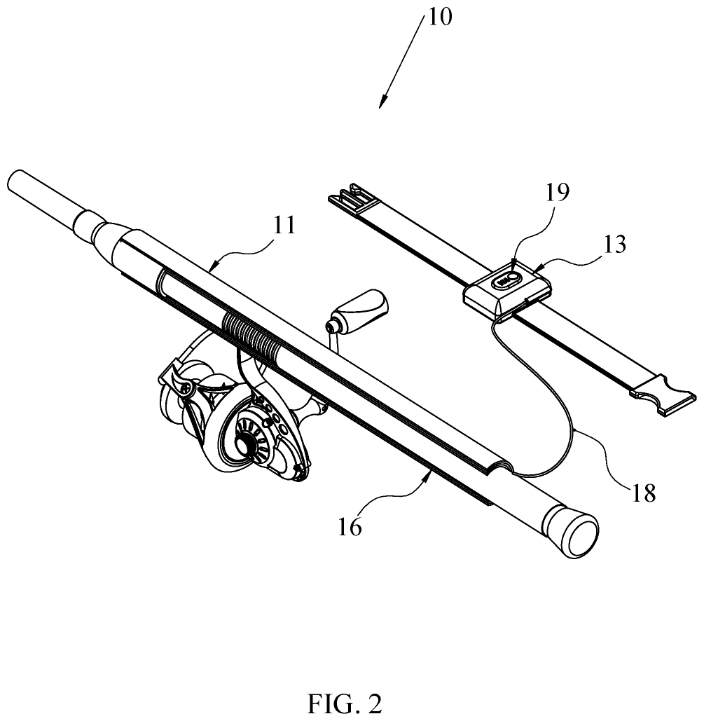

Shown in FIG. 2 is a perspective, partial cross section view of the flexible hand warmer device 10 depicted in FIG. 1 more specifically, the flexible hand warmer 11 can warm the hands of the user by connecting the power cord 18 from the heating controller 19, located on the portable battery pouch 13 to the heating element 16 which is built into the flexible hand warmer 11.

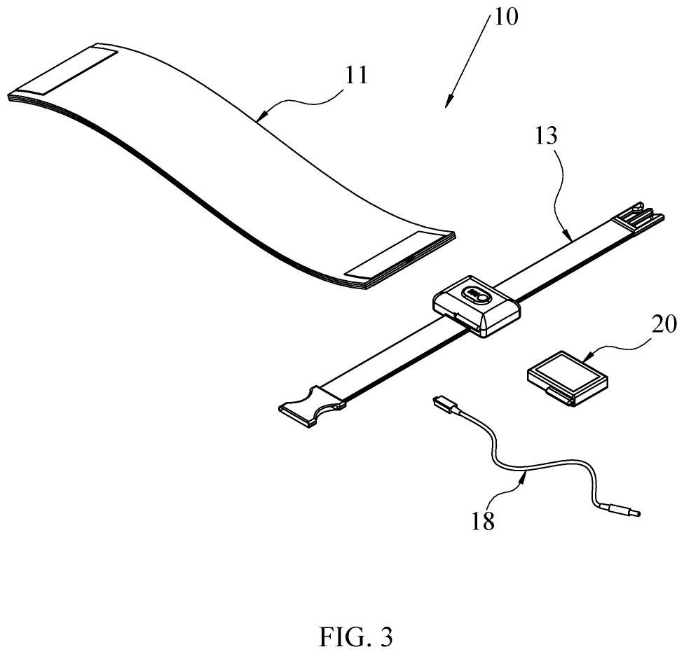

More specifically, as shown in FIG. 3 is a perspective view of the cold weather hand warmer device 10 showing the major components unattached, includes the flexible hand warmer 11, made of a flexible soft material combined with a built-in heating mechanism connected to a battery 20 located in the portable battery pouch 13 by a power cord 18.

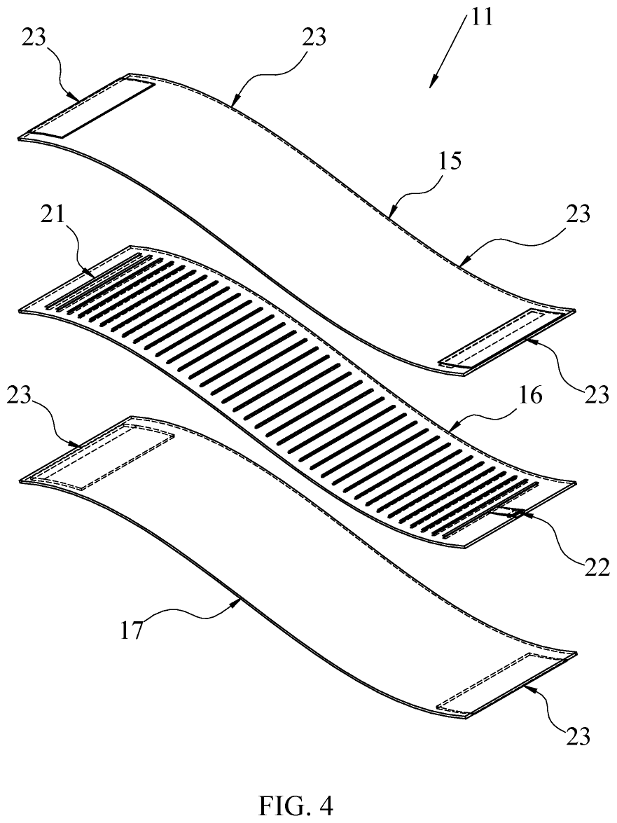

As shown in FIG. 4 is an exploded view of the flexible hand warmer 11 showing the relationship between components including durable fabric outer sleeve 15, heating element 16, insulation fabric sleeve 17 which are knitted, sewed or otherwise secured to each other. The durable fabric outer sleeve 15 is preferably made from an elastomer or texture waterproof fabric for ease of gripping and is comprised of a first hook and loop patch 23 or other means of attachment disposed on each end of the outer surface of the durable fabric outer sleeve 15. The heating element 16 is comprised of a carbon fiber heating coil 21 arranged in a serpentine configuration, preferred because it distributes the heat through the entire heating element 16 and a power connector jack 22 for connecting to the power source (not shown). The insulation fabric sleeve 17 is preferably made from insulation neoprene soft fabric or other flexible insulation material suitable for keeping the heat away from the wrapped surface. Attached on each end of the insulation fabric sleeve 17 will be the second hook and loop patch 23 or other means of attachment.

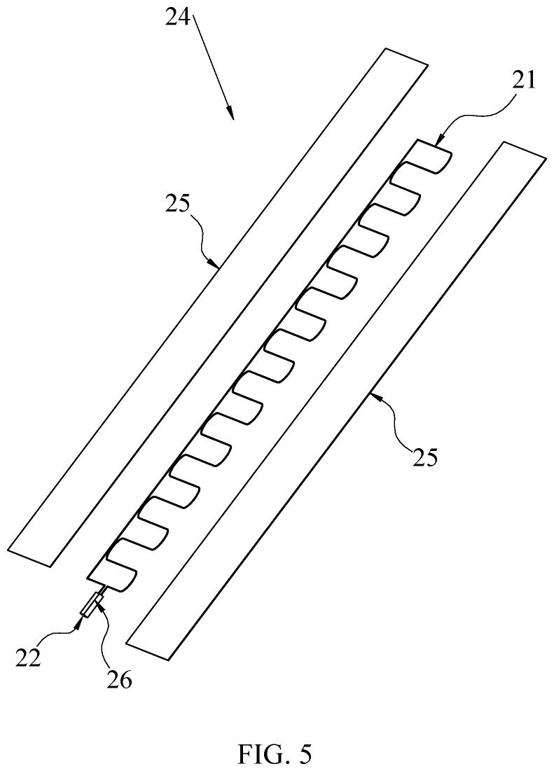

Moreover, as shown in FIG. 5 is a detail exploded view of the heating coil assembly 24 which includes the carbon fiber heating coil 21, electrically insulated protective liners 25 and the temperature sensor 26 together with the power connector jack 22 attached to the end of the carbon fiber heating coil 21.

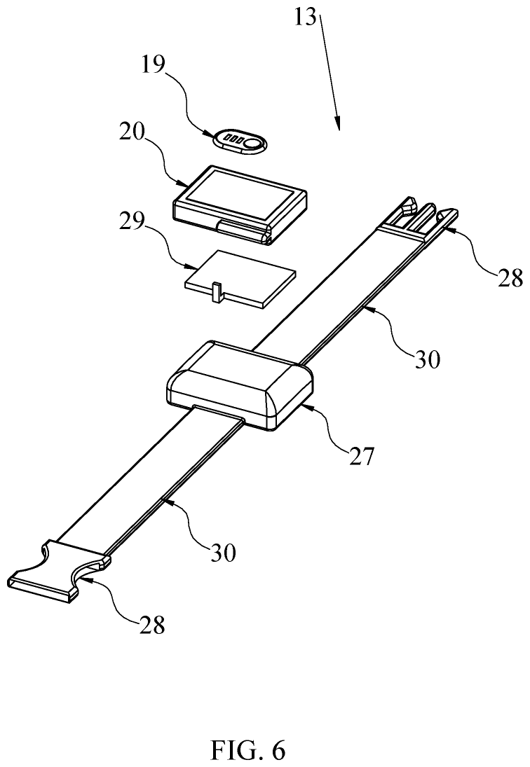

As shown in FIG. 6 is an exploded view of the portable battery pouch 13 showing the relationship between components including rechargeable battery 20, heating controller 19, and the control interface 28. The portable battery pouch 13 includes a battery pocket 27 for the rechargeable battery 20 and the control interface 28. The heating controller 19 can be attached to the outside of the battery pocket 27 for ease of use. Adjustable quick release buckles 29 are attached on each end of the battery pouch straps 30 for connecting to any surface.

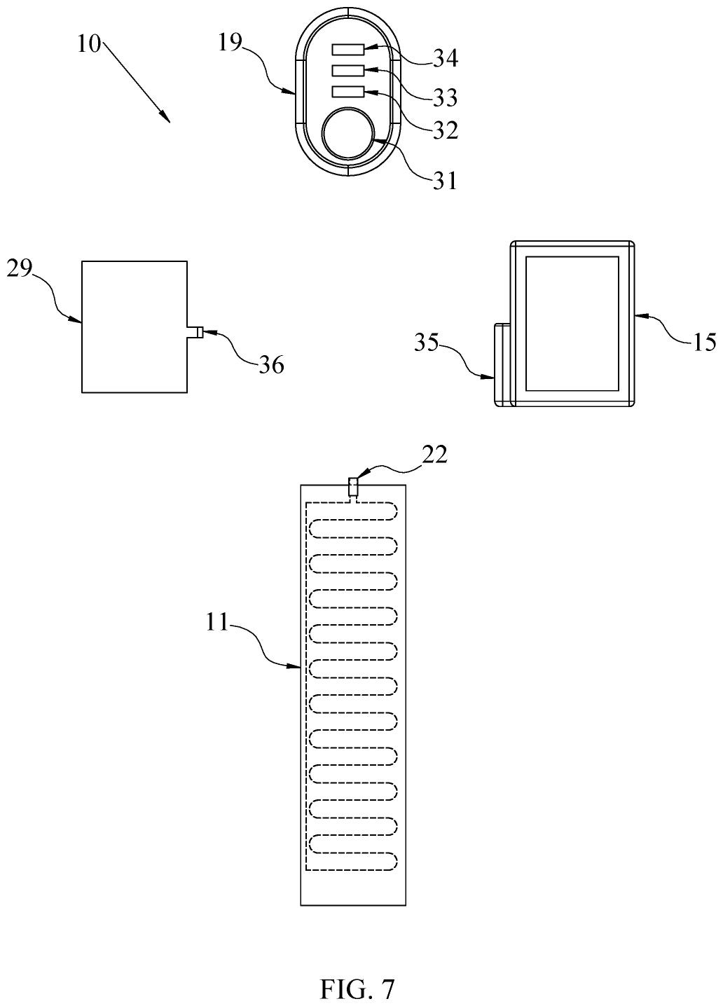

As best illustrates in FIG. 7, is a schematic view of the flexible hand warmer 11 manually-operated by the heating controller 19, which is electrically connected to the control interface 29 which in turn control the flow of power from the rechargeable battery 20. The heating controller 19 has an power on/off switch 31 comprises of four positions, a first position is for turning the device off, a second position is for providing a low amount of heat, a third position for providing a medium amount of heat and a forth position for providing a high amount of heat. A low temperature 32, medium temperature 33 and high temperature 34 indicator might be included with the heating controller 19 and/or other type of indicator letting the user know the status of the hand warmer 11. The control interface 28 is a fairly simple circuit interface working in conjunctions with the heating controller 19 and the rechargeable battery 20. In the control interface 28 could have the appropriate power circuitry, voltage regulator and a power switch for the control power from the rechargeable battery 20. The rechargeable battery 20 has power cord connector jack 35 that can be used for charging the battery and for connecting the rechargeable battery 20 to the control interface circuit board connector 36.

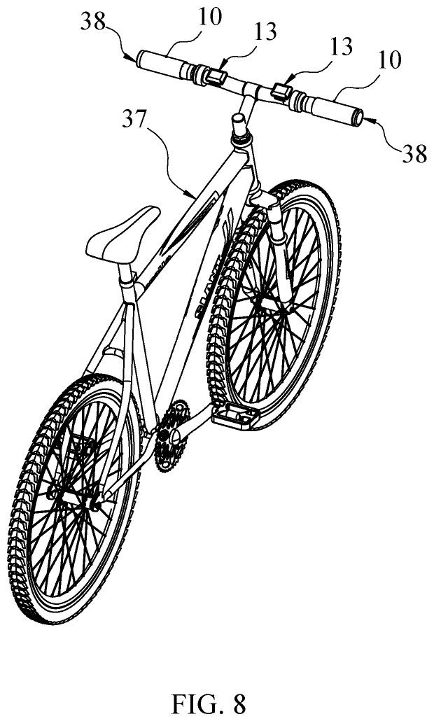

as shown in FIG. 8 is a illustrates view of a wheel chair 37 with the cold weather hand warmer device 10 attached to the wheel chair handles 38 including the portable battery pouch 13 positioned around the most convenient location.

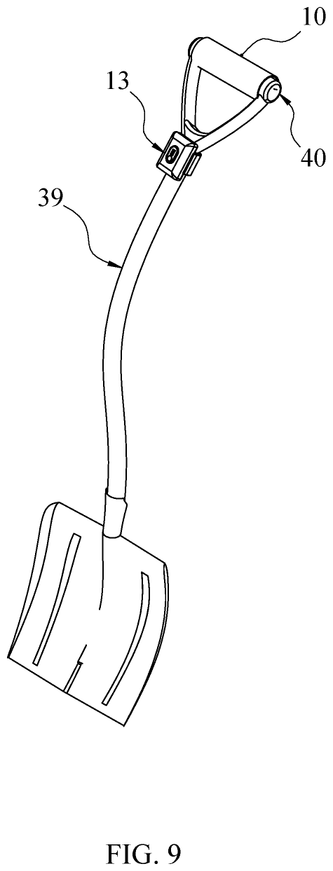

in accordance with embodiments of the present invention FIG. 9 is a illustrates view of a shovel 39 with the cold weather hand warmer device 10 attached to the shovel handles 40 including the portable battery pouch 13 positioned around the most convenient location.

What is claimed is:

1. A cold weather hand warmer device comprising:
a stand-alone flexible hand warmer with incorporated heating element and a portable battery pouch; wherein said flexible hand warmer includes 3 to 4 layer made from flexible soft material combined with a built-in heating mechanism in combination with a portable battery pouch attached by an electrical power cord;
a portable battery pouch including a rechargeable battery, a touch screen heating controller, control interface board, USB cable and an adjustable strap to help fix around most objects.

2. the cold weather hand warmer device once attached to a hand held object can be manually-operated by the heating controller which is electrically connected to the control interface which in turn controls the flow of power from the rechargeable battery.

3. A flexible heating hand warmer construction as recited by claim 1, wherein said flexible soft material is selected from a group consisting of 3M thinsulate insulation, soft cotton, polyester, spandex or elastomer.

4. a flexible heating hand warmer adapted for wrapping around a hand held object, the heating element being comprised of an interior heating element, the interior heating element having an heating coil, the heating element including an outer fabric sleeve and a fabric inter sleeve to receiving the interior heating element therein; a power cord directly connected to the innermost heating coil connector jack, extending directly outwardly from the outer cloth.

5. A flexible heating hand warmer of claim 1, wherein the patches means is comprised of a first hook and loop patch disposed on a first side of the outer fabric sleeve inwardly of a first end thereof and a second hook and loop patch disposed on a second side of the insulation fabric sleeve inwardly of a second end thereof, the first and second hook and loop patches mating with one another when the flexible heating hand warmer is wrapped around a hand held object.

6. The heating element sleeve with incorporated heating coil as set forth in claim 1, wherein the heating coil is disposed within a protective liner.

7. A flexible heating hand warmer construction as recited by claim 1, wherein said integral heating element is in a serpentine configuration.

8. The flexible heating hand warmer of claim 2, further including a thermostat positioned between the power source and the pouch to selectively control the temperature of the flexible heating element.

9. A flexible heating hand warmer construction as recited by claim 2, wherein said a heating element is inserted between said insulating material to thereby provide an intelligent safety feature (radiation-fee, shock proof, explosion-proof).

10. The flexible heating hand warmer of claim 2, further including an on/off switch included in the controller attached to the portable battery pouch.

11. A portable battery pouch including pocket a rechargeable battery, a touch screen heating controller, control interface board, and a USB cable. Wherein said portable battery pouch connected to said flexible hand warmer, and manually-operated controller supported by said battery-power assembly for controlling flow of electric power from said battery-power assembly to said heating element.

12. A portable battery pouch construction as recited by claim 1, wherein said batteries have an open circuit voltage and are chargeable from said USB power cord connection to a dual charger.

13. A portable battery pouch of claim 1, includes a heating controller with an power on/off switch comprises of four positions, a first position is for turning the device off, a second position is for providing a low amount of heat, a third position for providing a medium amount of heat and a forth position for providing a high amount of heat.

14. A portable battery pouch construction as recited by claim 1, wherein said batteries are rechargeable.

15. The portable battery pouch of claim 1, wherein the closing structure of the portable battery pouch straps for wrapping around a surface is selected from quick release buckle.
